(19) United States
(12) Patent Application Publication
(10) Pub. No.: US 2020/0356544 A1
(43) Pub. Date: Nov. 12, 2020

(54) FALSE POSITIVE DETECTION FOR ANOMALY DETECTION

(71) Applicant: Workday, Inc., Pleasanton, CA (US)

(72) Inventors: Sayan Chakraborty, Niwot, CO (US); Montiago Xavier LaBute, Oakley, CA (US); Saumil Shah, Santa Clara, CA (US); Madhura Dudhgaonkar, San Francisco, CA (US); Lakshminarayanan Renganarayana, Alameda, CA (US)

(21) Appl. No.: 16/405,816

(22) Filed: May 7, 2019

(51) Int. Cl. G06F 16/23; G06F 16/28; G06F 16/2455

(52) U.S. Cl. CPC G06F 16/2358; G06F 16/2455; G06F 16/284; G06F 16/2365

(57) ABSTRACT

A system for false positive detection includes an interface and a processor. The interface is configured to receive a transaction data. The processor is configured to determine whether the transaction data is a statistical outlier; in response to the transaction data being the statistical outlier: query database data to determine whether the transaction data is a false positive; and in response to the transaction data being the false positive, indicate that the transaction data is normal.

### BACKGROUND OF THE INVENTION

Transactional systems use artificial intelligence techniques to detect anomalous transaction data (e.g., journal lines, approvals, etc.). For example, anomalous transaction data is input to a transactional system as a result of error or fraud. It is advantageous to identify the anomalous transaction data to prevent the anomalous data from being processed by the system, causing incorrect data entry or updating. Techniques for identifying anomalous transaction data include machine learning techniques, neural networks, statistical anomaly detectors, etc. However, a key challenge in building an effective anomaly detector is being able to reduce a false positive rate (e.g., a rate at which the anomaly detector incorrectly identifies transaction data as anomalous, creating a problem where unnecessary errors are raised to the user, which might increase the likelihood the user will ignore real errors, or where good transaction data is not entered into the transactional system.

### BRIEF DESCRIPTION OF THE DRAWINGS

Various embodiments of the invention are disclosed in the following detailed description and the accompanying drawings.

FIG. 1 is a block diagram illustrating an embodiment of a network system.

FIG. 2A is a block diagram illustrating an embodiment of a transaction processing system.

FIG. 2B is a diagram illustrating an embodiment of a system for detecting false posititives.

FIG. 3 is a block diagram illustrating an embodiment of a tenanted database system.

FIG. 4 is a flow diagram illustrating an embodiment of a process for processing transaction data.

FIG. 5A is a flow diagram illustrating an embodiment of a process for determining whether transaction data comprises an unknown potential error.

FIG. 5B is a diagram illustrating an embodiment of objects and relationships encoding work process information.

FIG. 6A is a flow diagram illustrating an embodiment of a process for querying database data to determine whether the transaction data is a false positive.

FIG. 6B is a diagram illustrating an embodiment of a graph pattern query where a proposed anomaly is probably a true error given that it is inconsistent with work process information.

FIG. 6C is a diagram illustrating an embodiment of a graph pattern query where a proposed anomaly is probably a false positive given that it is consistent with work process information.

FIG. 7 is a flow diagram illustrating an embodiment of a process for determining using feedback whether an unknown potential error comprises an actual error.

FIG. 8 is a flow diagram illustrating an embodiment of a process for updating models.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for false positive detection is disclosed. The system comprises an interface and a processor. The interface is configured to receive a transaction data. The processor is configured to determine whether the transaction data is a statistical outlier, and in response to the transaction data being the statistical outlier, query database data to determine whether the transaction data is a false positive, and in response to the transaction data being the false positive, indicate that the transaction data is normal.

Anomaly detectors use a class of machine learning techniques to detect events (e.g., transactions, journal lines, approvals, etc.) that are not common or do not fit the normal business flows. A key challenge in building effective anomaly detectors is that of reducing the false alarm rate (e.g., the number of events that the system flags as anomalous, but are not anomalous in the broader business context. The system leverages a customer's business context as stored in an object graph to reduce false alarms.

A system for false positive detection comprises a transaction system coupled to a database system. For example, the transaction system comprises a system for receiving and processing financial transactions (e.g., comprising ledger data, cost center data, responsible employee data, etc.), and the database system comprises a human resources database system (e.g., comprising employee data and relationships, employee benefits data, employee performance data, business location data, etc.). The system for false positive detection receives financial transaction data (e.g., a transaction comprising a purchase, a payment, a transfer, etc.), and performs a series of tests to determine whether the data comprises good data (e.g., data likely to correctly represent a real transaction). The system for false positive detection first analyzes transaction data using a multi-category classifier (e.g., a set of machine learning classifiers). The multi-category classifier identifies whether the transaction data falls within one of a set of known error categories. In response to a determination that the transaction data falls within one of the set of known error categories, the transaction data is indicated as a known error. In response to a determination that the transaction data does not fall within one of the set of known error categories the transaction data is provided to a statistical outlier detector. The statistical outlier detector comprises a system trained on a large set of transaction data for determining statistically outlying transaction data (e.g., statistically outlying transaction data not associated with a known error type). For example, the statistical outlier detector comprises a machine learning model, a neural network system, an explicit algorithm, etc. In response to a determination that the transaction data is not a statistical outlier (e.g., a determination that the data comprises good data), the transaction data is processed as normal. In response to a determination that the transaction data comprises a statistical outlier, the transaction data is provided to a false positive detector for false positive detection.

The false positive detector comprises a system coupled to a database system. The false positive detector formulates a database query. The database query determines whether the transaction data is a false positive—for example, the database query is formulated based on the transaction data and data provided by the statistical outlier detector (e.g., data describing a statistical outlier type). A false positive use case indicating a query formulation is determined from the data provided by the statistical outlier detector. The query formulation is realized to a query based on the transaction data. The database is queried using the query, and the database response is analyzed to determine whether the transaction data comprises false positive data. In response to a determination that the transaction data comprises a false positive (e.g., a determination that the data comprises good data), the transaction data is processed as normal. In response to a determination that the transaction data does not comprise a false positive (e.g., a determination that the statistical outlier determination was correct), the transaction data is reported to the user as an error. Feedback data is collected from the user for further determination of whether the determination of the error was correct. For example, active feedback data is collected from the user by prompting the user for an indication of whether the error was correct, or passive feedback data is collected from the user by observing subsequent user actions (e.g., clearing the error, re-entering the transaction with modified data, etc.) to determine whether the error was correct. The multi-category classifier and/or the false positive detector are trained (e.g., using a supervised learning technique) based on the feedback data.

The system for false positive detection improves the computer system by utilizing the association of a transaction processing system and a database system to reduce the false positive error rate of the anomaly detector of the transaction processing system. Reducing the false positive error rate increases the likelihood that transactions will be processed correctly and that real errors will be recognized by the system user.

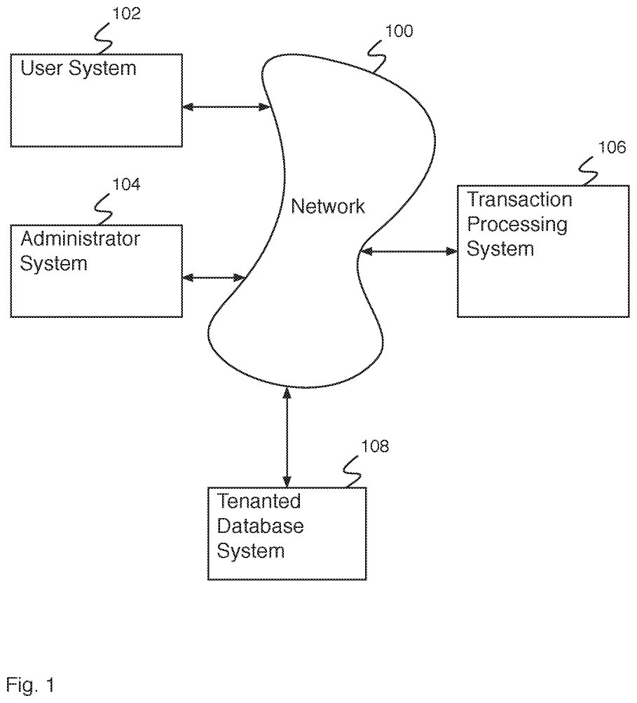

FIG. 1 is a block diagram illustrating an embodiment of a network system. In some embodiments, the network system of FIG. 1 comprises a network system for a system for tenant security control. In the example shown, FIG. 1 comprises network 100. In various embodiments, network 100 comprises one or more of the following: a local area network, a wide area network, a wired network, a wireless network, the Internet, an intranet, a storage area network, or any other appropriate communication network. User system 102, administrator system 104, transaction processing system 106, and tenanted database system 108 communicate via network 100. User system 102 comprises a user system for use by a user. For example, a user using user system 102 is associated with a tenant—for example, an organization client of tenanted database system 108. User system 102 stores and/or accesses data on tenanted database system 108—for example, within a tenanted data storage region. A user also uses user system 102 to interact with tenanted database system 108—for example, to store database data, to request database data, to create a report based on database data, to create a document, to access a document, to execute a database application, etc. A user uses user system 102 to interact with transaction processing system 106—for example, to provide transaction data (e.g., financial transaction data), to query the status of a transaction, to receive information about previous transactions, to receive an indication of a transaction error, etc. Transaction processing system 106 and tenanted database system 108 communicate via network 108—for example, to perform a database system query for determining whether a statistical outlier determination comprises a false positive.

Administrator system 104 comprises a system for performing administrative functions for associated systems (e.g., transaction processing system 106 and tenanted database system 108). Tenanted database system 108 comprises a database system for storing data associated with one or more tenants. For example, data stored by tenanted database system 108 is stored in one of a plurality of tenant storage regions of tenanted database system 108. Tenanted database system 108 additionally comprises a database system for retrieving data, preparing reports, responding to queries, etc. Transaction processing system 106 comprises a transaction processing system for receiving transaction data, processing transaction data, updating tenanted database system 108 based on transaction results, determining anomalous transactions, etc.

In the example shown, transaction processing system 106 includes a system for false positive detection. The system comprises an interface and a processor. The interface is configured to receive a transaction data. The processor is configured to determine whether the transaction data is a statistical outlier, and in response to the transaction data being the statistical outlier, query database data to determine whether the transaction data is a false positive, and in response to the transaction data being the false positive, indicate that the transaction data is normal.

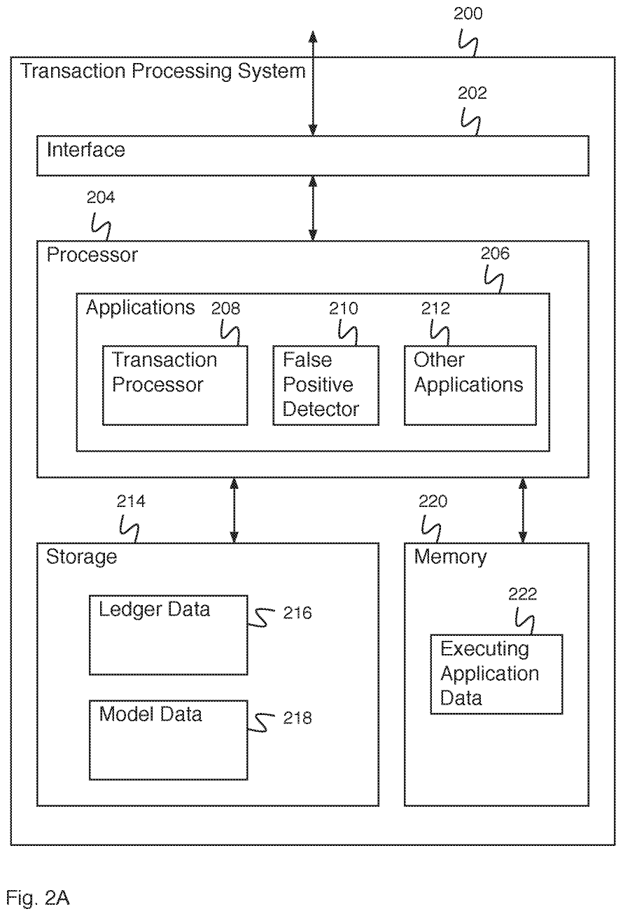

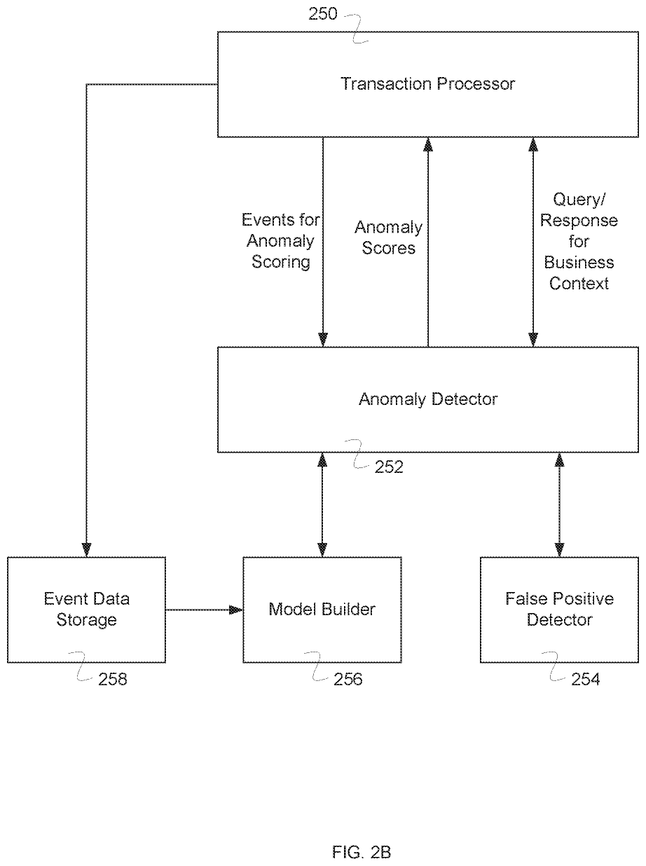

FIG. 2A is a block diagram illustrating an embodiment of a transaction processing system. In some embodiments, transaction processing system 200 of FIG. 2A comprises transaction processing system 106 of FIG. 1. In the example shown, transaction processing system 200 comprises interface 202. Interface 202 comprises an interface for communicating with external systems using a network. For example, interface 202 comprises an interface for communicating with a user system (e.g., for receiving a transaction data, for providing a user interface, for providing a transaction result, etc.). Processor 204 comprises a processor for executing applications 206. Applications 206 comprise transaction processor 208, false positive detector 210, and other applications 212. For example, false positive detector 210 comprises an application for determining whether transaction data is a statistical outlier and, in response to transaction data being a statistical outlier, querying database data to determine whether the transaction data is a false positive, and in response to the transaction data being the false positive, indicating that the transaction data is normal. Transaction processor 208 comprises an application for processing transaction data—for example, processing transaction data determined to be normal by false positive detector 210. Processing transaction data comprises determining a transaction result, updating ledger data, updating database data, etc. Other applications 212 comprises any other appropriate applications (e.g., a communications application, a chat application, a web browser application, a document preparation application, a data storage and retrieval application, a user interface application, a data analysis application, etc.).

Transaction processing system 200 additionally comprises storage 214. Storage 214 comprises ledger data 216 (e.g., comprising a transaction balance and a set of transactions updating the transaction balance) and model data 218 (e.g., model data describing one or more models of false positive detector 210—for example, models for one or more classifiers for determining whether the data falls within one of a set of known error categories, a model for a statistical outlier detector, a model for a false positive detector, etc.). Transaction processing system 200 additionally comprises memory 220. Memory 220 comprises executing application data 222 comprising data associated with applications 206.

FIG. 2B is a diagram illustrating an embodiment of a system for detecting false posititives. In some embodiments, transaction processor 250 and false positive detector 254 comprises transaction processor 208 and false positive detector 210 of FIG. 2A. In the example shown, transaction processor 250 processes customer transactions and work processes and creates data regarding the processing to be stored in event data storage 258. The data is used to train and develop models for anomaly detection by model builder 256. A model is provided to anomaly detector 252 by model builder 256. Anomaly detector 252 receives events from transaction processor 250 for scoring and using model determines a score. Anomaly detector 252 provides scores to transaction processor 250. In some cases, to determine whether the an event is a false positive, false positive detector 254 monitors anomaly scores provided by anomaly detector 252 to identify anomalous events and to query transaction processor 250 for business context (or other context) to help identify whether the anomalous events are false positives. In some embodiments, false positive detector 254 is part of anomaly detector 252.

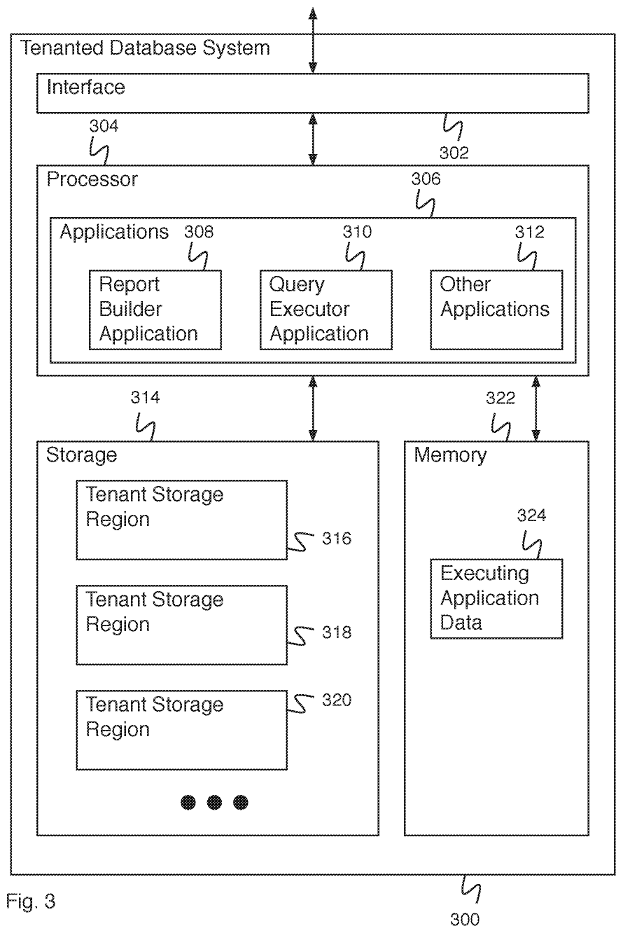

FIG. 3 is a block diagram illustrating an embodiment of a tenanted database system. In some embodiments, tenanted database system 300 of FIG. 3 comprises tenanted database system 108 of FIG. 1. In the example shown, tenanted database system 300 comprises interface 302. Interface 302 comprises an interface for communicating with external systems using a network (e.g., an interface for receiving data, providing data, receiving a query, providing a query result, receiving a request for a report, providing a report, etc.). Processor 304 comprises a processor for executing applications 306. Applications 306 comprises report builder application 308 for building reports based on data stored in storage 314. Applications 306 additionally comprises query executor application 310 for executing queries on data stored in storage 314. Applications 306 additionally comprises other applications 312, comprising any other appropriate applications (e.g., a communications application, a chat application, a web browser application, a document preparation application, a data storage and retrieval application, a user interface application, a data analysis application, etc.). Storage 314 comprises a data storage for storing tenant data. In various embodiments, tenant data stored by storage 314 comprises relational database data, an object graph, or any other appropriate data. Storage 314 comprises tenant storage region 316, tenant storage region 318, and tenant storage region 320. For example, storage 314 comprises any appropriate number of separate tenant storage regions. Each tenant storage region of storage 314 is associated with a different tenant. Data associated with a tenant is stored in the tenant storage region associated with that tenant. Memory 322 comprises executing application data 324 comprising data associated with applications 306.

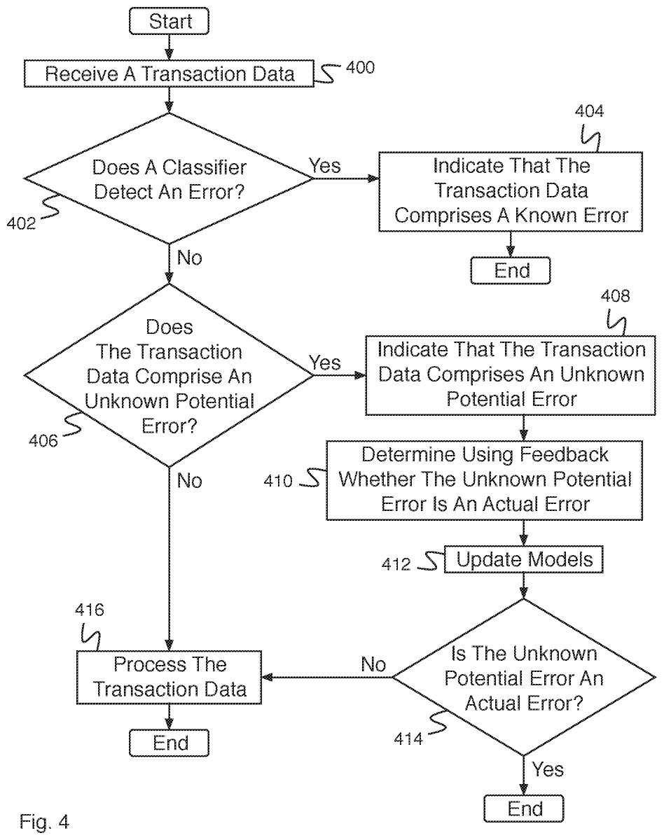

FIG. 4 is a flow diagram illustrating an embodiment of a process for processing transaction data. In some embodiments, the process of FIG. 4 is executed by transaction processing system 106 of FIG. 1. In the example shown, in 400, a transaction data is received. For example, the transaction data is received from a user via an interface. In various embodiments, the transaction data comprises one or more of the following: financial data, journal line data, record-based data, human resources system data, or any other appropriate data. In 402, the process determines whether a classifier detects an error. In various embodiments, the classifier comprises one or more classifiers, one or more multi-category classifiers, a model-based classifier, a machine learning classifier, a neural network classifier, or any other appropriate classifier. In response to determining that the classifier detects an error, control passes to 404. In 404, the process indicates that the transaction data comprises a known error, and the process ends. In response to determining that the classifier does not detect an error, control passes to 406. In 406, it is determined whether the transaction data comprises an unknown potential error. In the event it is determined that the transaction data does not comprise an unknown potential error, control passes to 416. In the event it is determined that the transaction data comprises an unknown potential error, control passes to 408. In 408, the process indicates that the transaction data comprises an unknown potential error. For example, the process indicates to a user that the transaction data comprises an unknown potential error. In 410, it is determined, using feedback, whether the unknown potential error is an actual error. In 412, models are updated. For example, the models are updated using the feedback. In 414, it is determined whether the unknown potential error is an actual error. In the event that the unknown potential error comprises an actual error, the process ends. In the event that the unknown potential error does not comprise an actual error, control passes to 416. In 416, the transaction data is processed.

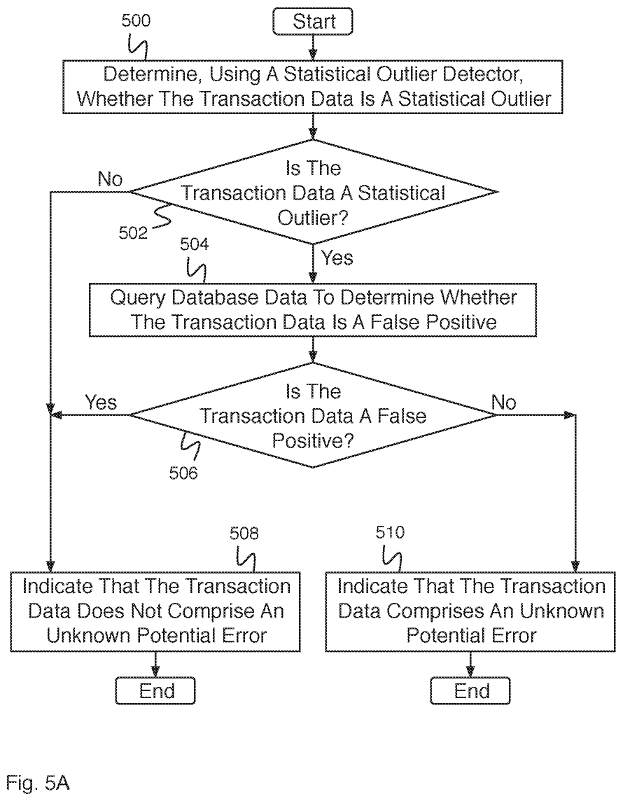

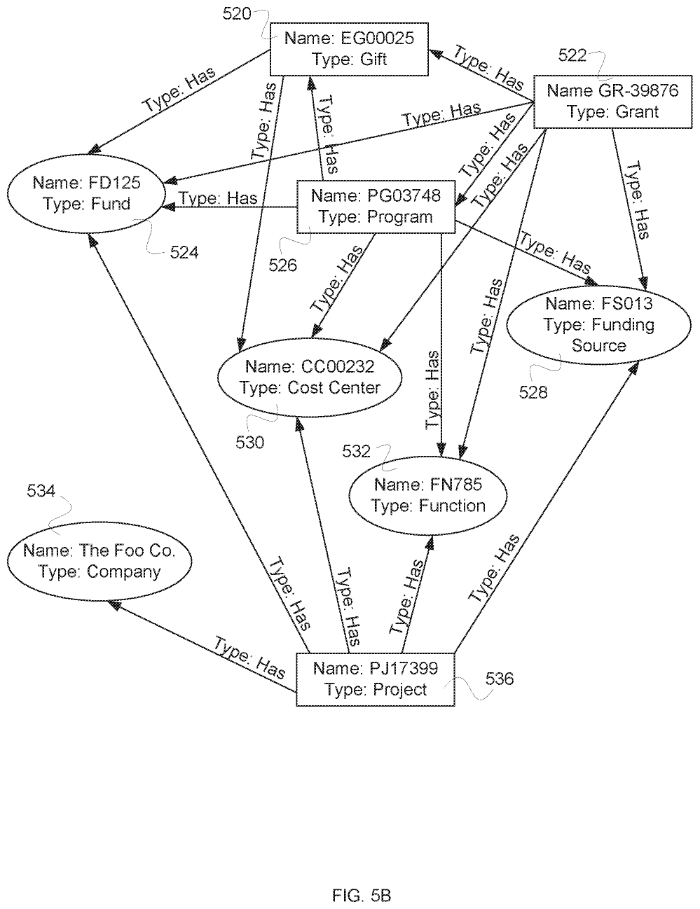

FIG. 5A is a flow diagram illustrating an embodiment of a process for determining whether transaction data comprises an unknown potential error. In some embodiments, the process of FIG. 5A implements 406 of FIG. 4. In the example shown, in 500, the process determines, using a statistical outlier detector, whether the transaction data is a statistical outlier. In 502, in the event that the transaction data is not a statistical outlier, control passes to 508. In the event that the transaction data is a statistical outlier, control passes to 504. In 504, database data is queried to determine whether the transaction data is a false positive. For example, database data used to determine the validity of the transaction data. In various embodiments, validity of the transaction data is determined based at least in part on one or more of the following: whether a set of relationships is adhered to, whether a set of rules is adhered to, whether a set of business logic is adhered to, whether a set of metadata is consistent with existing metadata constructs, or any other appropriate database consistency is adhered to. In some embodiments, the false positive determination includes determining whether the transaction data is a statistical outlier. In 506, in response to determining that the transaction data is a false positive, control passes to 508. In response to determining that the transaction data is not a false positive, control passes to 510. In 508, the process indicates that the transaction data does not comprise an unknown potential error, and the process ends. In 510, the process indicates that the transaction data comprises an unknown potential error, and the process ends.

FIG. 5B is a diagram illustrating an embodiment of objects and relationships encoding work process information. In some embodiments, the graph of FIG. 5B encodes database data used to determine validity of transaction data for a query as in 504 of FIG. 5A. The database data of interest is typically a set of relationships or rules that exist amongst a set of objects. This set of objects and relationships encodes work process information for the tenant and can be thought of as a graph. In the example shown, entities are depicted with their relationships that are critical to a hypothetical educational institution tenant's financial operations. In this case, there is a set of driver entities (e.g., Gift 520, Program 526, Project 536, Grant 522) that are associated with other, secondary entities that are required to conduct business functions (e.g., Fund 524, Company 534, Cost Center 530, Funding Source 528, and Function 532). Gift 520 has name EG00025 and type Gift and originates relations type: has with Fund 524, Cost Center 530. Grant 522 has name GR-39876 and name Grant and originates relations type: has with Gift 520, Fund 524, Program 526, Cost Center 530, Function 532, and Funding Source 528. Fund 524 has name FD125 and type Fund and originates no relations. Program 526 has name PG03748 and type Program and originates relations type: has with Gift 520, Fund 524, Cost Center 530, Function 523, and Funding Source 528. Funding Source 528 has name FS013 and type Funding Source and originates no relations. Cost Center 530 has name CC00232 and type Cost Center and originates no relations. Function 532 has name FN785 and type Function and originates no relations. Company 534 has name The Foo Co. and type Company and originates no relations. Project 536 has name PJ17399 and type Project and originates relation type: has with Company 534, Fund 524, Cost Center 530, Function 532, and Funding Source 528. In some embodiments, these entities are termed “tags”, which are generally metadata associated with transactions. Incoming transaction data that are determined to be statistical outliers will possess values for each of these dimensions and will be deemed a “false positive” if the business logic is preserved. If transactions do not conform to the business logic embodied by the graph in Figure A, that transaction is deemed to be a statistical outlier, which is not a known error, but is at a high probability of being an error since it does not conform to pre-defined work processes and logic. These instances will be surfaced to the user to elicit more guidance via feedback mechanisms.

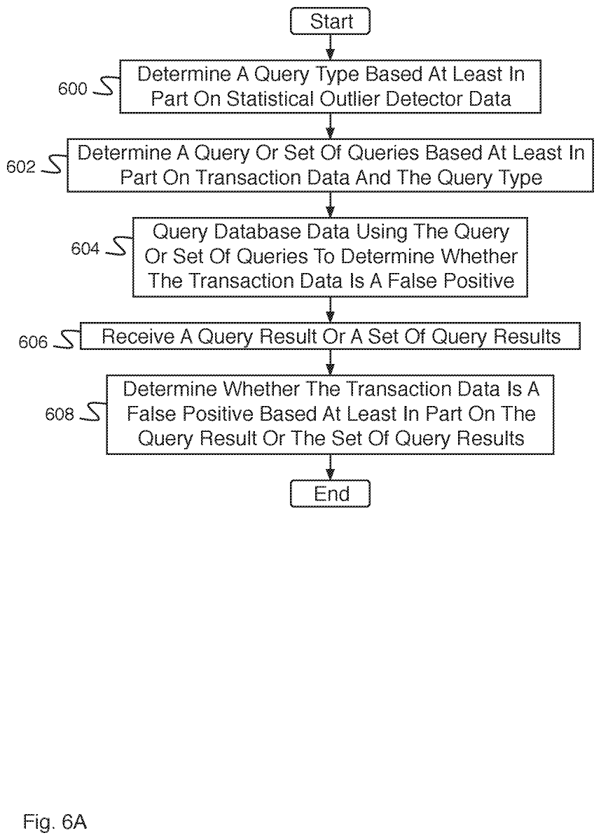

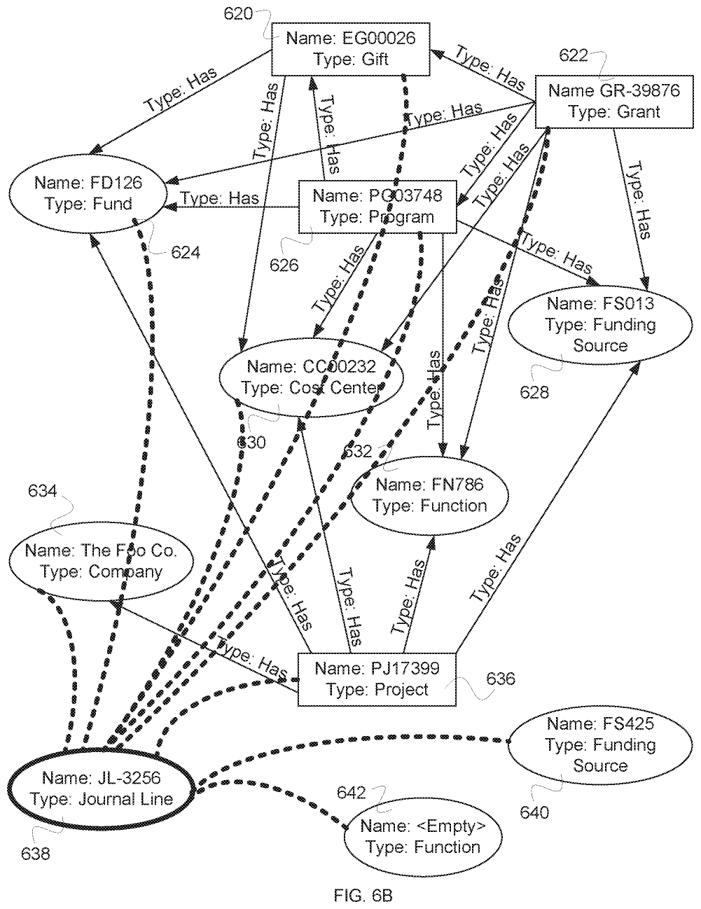

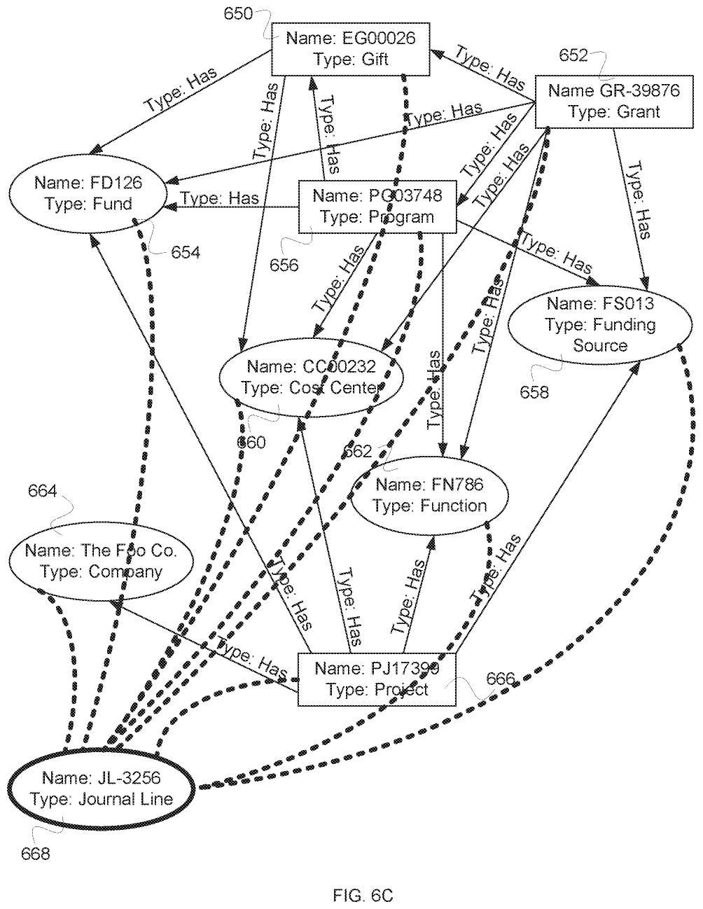

FIG. 6A is a flow diagram illustrating an embodiment of a process for querying database data to determine whether the transaction data is a false positive. In some embodiments, the process of FIG. 6A implements 504 of FIG. 5A. In the example shown, in 600, a query type is determined based at least in part on statistical outlier detector data. In some embodiments, a statistical outlier detector outputs data indicating that the transaction data comprises a statistical outlier and indicating a statistical outlier type, and a query type is determined based on the statistical outlier type. In 602, a query or set of queries is determined based at least in part on transaction data and the query type. For example, the query type comprises a query template that is filled in using transaction data. In 604, database data is queried using the query or set of queries to determine whether the transaction data is a false positive. In 606, a query result or a set of query results is received. In 608, it is determined whether the transaction data is a false positive based at least in part on the query result or the set of query results.

In some embodiments, a query type comprises a short edit distance query type. Querying database data to determine whether the transaction data is a false positive using a short edit distance query type comprises querying database data to determine whether the transaction data comprises a short edit distance to transaction data not comprising a statistical outlier. For example, a short edit distance comprises a changed tag, a changed field of an address, or a changed digit of an identification number.

FIG. 6B is a diagram illustrating an embodiment of a graph pattern query where a proposed anomaly is probably a true error given that it is inconsistent with work process information. In some embodiments, the graph of FIG. 6B encodes database data used to determine validity of transaction data for a query as in 504 of FIG. 5A. The database data of interest is typically a set of relationships or rules that exist amongst a set of objects. This set of objects and relationships encodes work process information for the tenant and can be thought of as a graph. In the example shown, entities are depicted with their relationships that are critical to a hypothetical educational institution tenant's financial operations. In this case, there is a set of driver entities (e.g., Gift 620, Program 626, Project 636, Grant 622) that are associated with other, secondary entities that are required to conduct business functions (e.g., Fund 624, Company 634, Cost Center 630, Funding Source 628, and Function 632). Gift 620 has name EG00025 and type Gift and originates relations type: has with Fund 624, Cost Center 630. Grant 622 has name GR-39876 and name Grant and originates relations type: has with Gift 620, Fund 624, Program 626, Cost Center 630, Function 632, and Funding Source 628. Fund 624 has name FD125 and type Fund and originates no relations. Program 626 has name PG03748 and type Program and originates relations type: has with Gift 620, Fund 624, Cost Center 630, Function 623, and Funding Source 628. Funding Source 628 has name FS013 and type Funding Source and originates no relations. Cost Center 630 has name CC00232 and type Cost Center and originates no relations. Function 632 has name FN785 and type Function and originates no relations. Company 634 has name The Foo Co. and type Company and originates no relations. Project 636 has name PJ17399 and type Project and originates relation type: has with Company 634, Fund 624, Cost Center 630, Function 632, and Funding Source 628. In addition, the system evaluates statistical outlier Journal Line 638. Journal Line 638 has name JL-3256 and type Journal Line and originates relations type: has with Gift 620, Grant 622, Program 626, Cost Center 630, Project 636, Company 634, Fund 624, Funding Source 640, and Function 642. Funding Source 640 has name FS425 and type Funding Source and originates no relations. Function 642 nas name <Empty> and type Function and originates no relations. The journal line is evaluated to be a statistical outlier by querying the driver-related tags in the graph shown in FIG. 6B. The graph representing the transaction data associated with Journal Line 638 (e.g., Name: JL-3256, type: Journal Line, Gift: EG00025, Grant: GR-39876, Program: PG03748, Cost Center: CC00232, Prject: PJ17399, Company: The Foo Co., Fund: FD125, Funding Source: FS425, and Function: <Empty>) violates the relationship rules. Namely, according the work process graph, the ‘Funding Source’ field should be FS013 and the ‘Function’ field should have the value FN785 as those are the objects linked with the rest of the associated objects in the graph. The incoming transaction data conforms to all rules except that it has ‘Funding Source’=FS425 and that the ‘Function’ field is empty. From the system concludes that JL-3256 does not conform to the rule patterns and so there is a high probability that JL-3256 is an erroneous transaction. Moreover, the database query can auto-generate a suggestion for a manual correction, where all fields are the same except that it has recommendations {Funding Source: FS013, Function: FN785}.

FIG. 6C is a diagram illustrating an embodiment of a graph pattern query where a proposed anomaly is probably a false positive given that it is consistent with work process information. In some embodiments, the graph of FIG. 6C encodes database data used to determine validity of transaction data for a query as in 504 of FIG. 5A. The database data of interest is typically a set of relationships or rules that exist amongst a set of objects. This set of objects and relationships encodes work process information for the tenant and can be thought of as a graph. In the example shown, entities are depicted with their relationships that are critical to a hypothetical educational institution tenant's financial operations. In this case, there is a set of driver entities (e.g., Gift 650, Program 656, Project 666, Grant 652) that are associated with other, secondary entities that are required to conduct business functions (e.g., Fund 654, Company 664, Cost Center 660, Funding Source 658, and Function 662). Gift 650 has name EG00025 and type Gift and originates relations type: has with Fund 654, Cost Center 660. Grant 652 has name GR-39876 and name Grant and originates relations type: has with Gift 650, Fund 654, Program 656, Cost Center 660, Function 662, and Funding Source 658. Fund 654 has name FD125 and type Fund and originates no relations. Program 656 has name PG03748 and type Program and originates relations type: has with Gift 650, Fund 654, Cost Center 660, Function 653, and Funding Source 658. Funding Source 658 has name FS013 and type Funding Source and originates no relations. Cost Center 660 has name CC00232 and type Cost Center and originates no relations. Function 662 has name FN785 and type Function and originates no relations. Company 664 has name The Foo Co. and type Company and originates no relations. Project 666 has name PJ17399 and type Project and originates relation type: has with Company 664, Fund 654, Cost Center 660, Function 662, and Funding Source 658. In addition, the system evaluates statistical outlier Journal Line 668. Journal Line 668 has name JL-3256 and type Journal Line and originates relations type: has with Gift 650, Grant 652, Program 656, Cost Center 660, Project 666, Company 664, Fund 654, Funding Source 658, and Function 662. The second query validation we consider is shown in FIG. 6C. The system has an incoming transaction that is evaluated to be a statistical outlier (i.e. anomalous because it has a rare combination of features). Upon querying the driver-related tags associated with the graph in FIG. 5B, it is found that it completely conforms to all known rules. The fact it is a statistical anomaly could be related to the fact that it is rare or it reflects a recent change in a work process, where the rules in the system have been changed but not many transaction instances have been generated because it may represent a new line of business. In this case, since it conforms to all known rules, the system treats it as a false positive, and it is not surfaced to the user.

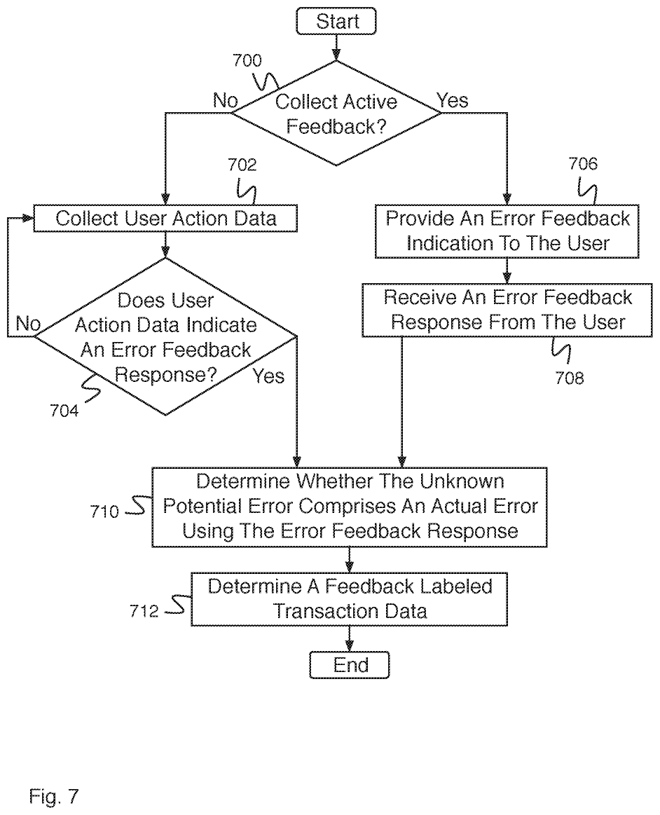

FIG. 7 is a flow diagram illustrating an embodiment of a process for determining using feedback whether an unknown potential error comprises an actual error. In some embodiments, the process of FIG. 7 implements 410 of FIG. 4. In the example shown, in 700, it is determined whether to collect active feedback. For example, it is determined whether to collect active feedback based at least in part on a design decision, an active feedback collection frequency, a query type, a random number, etc. In the event it is determined not to collect active feedback, control passes to 702. In 702, user action data is collected. For example, user action data is collected where there is more than one action such as a set of user actions (e.g., clearing an error message, resubmitting a modified transaction, etc.). In 704, it is determined whether action data indicates an error feedback response. For example, the error feedback response can or cannot be determined from the collected user action data. In the event it is determined that the user action data does not indicate an error feedback response, control passes to 702 (e.g., more user action data is collected). In some embodiments, after a predetermined period of time collecting user action data, no more user action data is collected. In the event it is determined in 704 that user action data indicates an error feedback response, control passes to 710.

In the event it is determined in 700 to collect active feedback, control passes to 706. In 706, an error feedback indication is provided to the user. For example, an error feedback indication comprises a user interface object for requesting a feedback response indicating whether the unknown potential error comprises an actual error. In 708, an error feedback response is received from the user. In 710, it is determined whether the unknown potential error comprises an actual error using the error feedback response. In 712, a feedback labeled transaction data is determined.

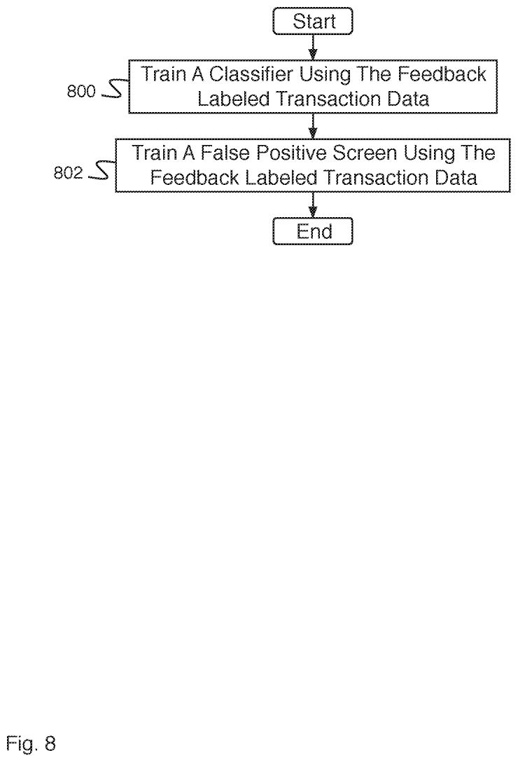

FIG. 8 is a flow diagram illustrating an embodiment of a process for updating models. In some embodiments, the process of FIG. 8 implements 412 of FIG. 4. In the example shown, in 800, a classifier is trained using the feedback labeled transaction data. In 802, a false positive screen is trained using the feedback labeled transaction data.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for false positive detection comprising:
an interface configured to receive a transaction data; and
a processor configured to:
determine whether the transaction data is a statistical outlier; and
in response to the transaction data being the statistical outlier:
query database data to determine whether the transaction data is a false positive; and
in response to the transaction data being the false positive, indicate that the transaction data is normal.

2. The system of claim 1, wherein the processor is further configured to determine whether there is an error detected using a classifier.

3. The system of claim 2, wherein the classifier comprises a multi-category classifier.

4. The system of claim 2, wherein the classifier comprises a model-based classifier.

5. The system of claim 2, wherein the processor is further configured to indicate that the transaction data comprises a known error in response to determining that the error is detected using the classifier.

6. The system of claim 2, wherein the processor is further configured to determine whether the transaction data is a statistical outlier in response to determining that the error is not detected using the classifier.

7. The system of claim 1, wherein the processor is further configured to indicate that the transaction data does not comprise an unknown potential error in response to the transaction data not being the statistical outlier.

8. The system of claim 1, wherein the processor is further configured to indicate that the transaction data is an unknown potential error in response to the transaction data not being the false positive.

9. The system of claim 8, wherein the processor is further configured to determine using feedback whether the unknown potential error is an actual error in response to the transaction data not being the false positive.

10. The system of claim 9, wherein feedback comprises active feedback or passive feedback.

11. The system of claim 9, wherein the processor is further configured to use the feedback to train a false positive screen.

12. The system of claim 9, wherein the processor is further configured to use the feedback to train a classifier.

13. The system of claim 1, wherein the database data is stored using a database system.

14. The system of claim 1, wherein the database data comprises an object graph.

15. The system of claim 1, wherein the database data comprises relational database data.

16. The system of claim 1, wherein querying the database data to determine whether the transaction data is a false positive comprises querying the database data to determine whether the transaction data comprises a short edit distance to transaction data not comprising a statistical outlier.

17. The system of claim 16, wherein the short edit distance comprises at least one of: a changed tag, a changed field of an address, or a changed digit of an identification number.

18. The system of claim 1, wherein the transaction data comprises at least one of: financial data, journal line data, record-based data, or human resources system data.

19. A method for false positive detection comprising:
receiving a transaction data;
determining, using a processor, whether the transaction data is a statistical outlier; and
in response to the transaction data being the statistical outlier:
querying database data to determine whether the transaction data is a false positive; and
in response to the transaction data being the false positive, indicating that the transaction data is normal.

20. A computer program product for false positive detection, the computer program product being embodied in a non-transitory computer readable storage medium and comprising computer instructions for:
receiving a transaction data;
determining whether the transaction data is a statistical outlier; and
in response to the transaction data being the statistical outlier:
querying database data to determine whether the transaction data is a false positive; and
in response to determining the transaction data being the false positive, indicating that the transaction data is normal.
